(19) United States
(12) Patent Application Publication
(10) Pub. No.: US 2013/0108987 A1
(43) Pub. Date: May 2, 2013

(54) ANALOG POSITIONER

(71) Applicants: Silvio Blumenthal, Basel (CH); Steffen Kuehne, Basel (CH)

(72) Inventors: Silvio Blumenthal, Basel (CH); Steffen Kuehne, Basel (CH)

(73) Assignee: Straumann Holding AG, Basel (CH)

(21) Appl. No.: 13/701,138

(22) PCT Filed: Jun. 10, 2011
(86) PCT No.: PCT/EP2011/002845

§ 371 Date: Dec. 21, 2012

(30) Foreign Application Priority Data
Jun. 10, 2010 (EP) 10005988.0

(51) Int. Cl. A61C 8/00; A61C 5/10

(52) U.S. Cl. CPC A61C 8/0022; A61C 8/005; A61C 5/10
USPC 433/174

(57) ABSTRACT

Analog positioner (50) for fitting an analog (14) into place during preoperative planning. The analog positioner (50) includes a holder (10) and at least one intermediate piece (210) for temporarily fixing the analog (14) to the holder (10). The holder (10) has a shaft (16) having a receptacle section (18), to be held in receptacle means of a computer-controlled positioning unit, and, adjoining axially thereto, a positioning section (20) having an attachment unit (22). The receptacle section (18) is arranged at a first holder end and the attachment unit (22) is arranged at a second holder end lying axially opposite the receptacle section (18). The positioning section (20) has a reference element (28). The intermediate piece (210) has a longitudinal axis (218), a first end (211) having a holder receptacle region (212) for connecting in a releasable fashion the intermediate piece (210) to the attachment unit (22) of the holder (10) and a second end, lying axially opposite the first end, having an analog receptacle region (216) for temporarily holding the analog (14).

### FIELD OF THE INVENTION

The present invention relates to an analog positioner comprising a holder and an intermediate piece for positioning an implant analog in a model and also to a set comprising the analog positioner and at least one analog.

### BACKGROUND

The use of dental implants as an artificial replacement for dental roots has become established practice in recent years. There are various types of dental implants, with the screw-type implants (e.g. WO 97/49351) in particular having proven their worth. Use is typically made of dental implants made of titanium or various ceramics.

Screw-type dental implants usually consist of an anchoring part for anchoring the implant in the bone and an abutment onto which a superstructure can be attached. If anchoring part and abutment are formed as a single component, this is a one-piece implant. If the anchoring part and the abutment are embodied as two separate components, this is referred to as a two-piece implant.

In order to affix a screw-type dental implant into the bone, the implant is screwed into a fitting drilled hole in the jaw of the patient. Then a superstructure, a prosthetic element, a bridge, crown or else—in the case of a two-piece implant—a tertiary part is attached to the abutment of an implant.

For the purpose of preoperative planning of a surgical intervention, in which an implant is implanted into the jaw of a patient, a model of the jaw or the implantation site and the surroundings thereof has been found to be very useful. To this end, a CT scan of the jaw of the patient is initially created and the precise position and orientation of the implant(s) to be fitted into place are determined on a computer with the aid of suitable software. A model of the jaw or of the implantation site and the surroundings thereof is then produced on the basis of this planning, for example by means of 3D-plotting. During 3D-plotting, the model is preferably produced directly with “drilled holes” at the planned implantation sites. However, alternatively, it is also possible for the model initially to be produced without drilled holes and for the latter to be subsequently drilled. The drilled holes in the model are preferably drilled with the aid of a computer-controlled drill device because the latter ensures very high drilling precision. However, alternatively, the drilled holes can also be produced manually on the basis of the computer planning. In this case, the drilled hole is usually made to be slightly larger than would actually be required for the analog such that the analog can still be brought into the correct position and affixed in the model, even in the case of a certain amount of imprecision during drilling, with a possible cavity around the analog being filled by a suitable filler material. For reasons of simplicity, all holes in the model will be described as “drilled holes” within the scope of this application, irrespective of the production thereof.

After the preoperative planning on the computer, the model can be useful for checking the implant axis, selecting the implant and determining the abutment, as well as in the manufacture of the superstructure.

One or more implant imitations or replicas, so-called analogs, can be inserted into such a model. The analog substantially consists of the same parts as an implant. It is usual for a corresponding analog to be used for each embodiment of an implant, the size and dimensions of which analog corresponding to those of the implant. The analog therefore comprises an anchoring part, which is intended to be anchored in a model. At the coronal end thereof, the analog has receptacle means, corresponding to the respective implant, for holding an abutment or a superstructure.

During the preoperative planning, the analog is inserted into the model in the previously prepared drilled hole at the planned site on the basis of the coordinates determined by the computer. After the analog has been inserted into the model, an abutment and/or a superstructure, as is used to reconstruct the teeth row, can subsequently be inserted into the receptacle means of the analog. With the aid of the model, it is thus possible to imitate the design as should be used for the implantation. In addition to the alignment and position of the subsequent implant, this also allows esthetic aspects of the prosthesis, such as the dimensions of a crown, to be checked.

WO2009/105508 describes a method for inserting a dental implant analog into a model. Here, a robot initially processes the model and produces a drilled hole for the implant analog. Subsequently, the robot places the analog on the planned implantation site, which is usually determined in advance with the aid of a three-dimensional computer model.

For the purposes of preparing the “proper” drilled hole in the jaw bone during the surgical intervention, use is usually made of a drill pattern. Such drill patterns serve to guide dental drills and prevent slipping or kinking during the drilling process. As a result of guiding the dental drill in the drill pattern, it is possible to ensure a precise alignment of the drilled hole and hence of the implant in accordance with the planning. The drill pattern can also be used together with the model. To this end, it is placed on the teeth row of the model. Then the drilled hole can, with the aid of the drill pattern, initially be drilled into the model for the analog and the analog can subsequently be placed.

The dimensions of the analog to be fitted into place in the model preferably correspond to the dimensions of the implant that is to be used for the surgical intervention. Initially, a hole, which largely in terms of position, alignment and depth corresponds to the planned implant drilled hole in the jaw bone of the patient, is drilled into the model. Optionally, this occurs with the aid of a previously made drill pattern or a computer-controlled drilling device. Alternatively, the model can already be produced with the “drilled holes”, for example by means of 3D plotting. The analog is subsequently inserted into the drilled hole.

Manually fitting the analog into place in the drilled hole can be found to be quite difficult for less experienced users since the analog often only has a length of a few millimeters and the drilled hole is often situated at poorly accessible sites in the model. In particular, if the analog is fitted into place by hand, the position thereof may be too imprecise. However, it is of greatest importance for an optimum implantation that position, alignment (in the direction of rotation), inclination and depth of the analog in the model precisely correspond to the orientation determined using the computer.

On the other hand, when the analog is fitted into place under computer control in a known fashion, for example by means of a robot, the positioning itself can theoretically be carried out with great accuracy, but the robot is typically already calibrated prior to the application of the drilled holes. Hence a tool change—removing the drill and inserting an analog holder—is required before the analog is fitted into place, which in turn makes the system susceptible to errors and can lead to a loss of calibration accuracy.

### SUMMARY OF THE INVENTION

It is therefore an object of the present invention to provide means with the aid of which it is made easier and simpler to fit an analog into place in a drilled hole in a model and it is possible to guarantee great precision in respect of position and alignment of the analog.

The present invention relates to an analog positioner for positioning an analog in a model. The analog positioner according to the invention comprises a holder and at least one intermediate piece for temporarily fixing the analog to the holder. The holder comprises a shaft having a receptacle section, to be held in receptacle means of a computer-controlled positioning unit, and, adjoining axially thereto, a positioning section. The latter has an attachment unit, preferably for connecting in a releasable fashion the intermediate piece to the holder. The receptacle section is arranged at a first holder end and the attachment unit is arranged at a second holder end lying axially opposite the receptacle section. The positioning section has a reference element.

The intermediate piece has a longitudinal axis, a first end having a holder receptacle region for connecting in a releasable fashion the intermediate piece to the attachment unit of the holder and a second end, lying axially opposite the first end, having an analog receptacle region for temporarily holding the analog.

The analog positioner according to the invention renders it possible to insert the analog into the model with the aid of a computer-controlled positioning unit. With the aid of the holder attached to the computer-controlled positioning unit, it is possible to calibrate the computer-controlled positioning unit. Thereafter, the analog positioner according to the invention, which renders it possible to hold and position the analog, is obtained by attaching the intermediate piece on the holder, without the need for tools to be interchanged or replaced on the computer-controlled positioning unit. As a result, it is possible to avoid imprecision when placing the analog and, in particular, also to avoid a loss of calibration accuracy, and so the fully-equipped model can impart upon the user an accurate visual impression of the subsequent conditions in the mouth of the patient. The model with the inserted analogs serves the user in particular as a basis for producing custom-fit crowns and abutments.

The holder of the analog positioner is connected to the computer-controlled positioning unit by virtue of anchoring the receptacle section, arranged on the shaft thereof, in the receptacle means of the computer-controlled positioning unit. In the process, the holder is preferably attached to the receptacle means of the computer-controlled positioning unit by means of a snap lock. Alternatively, it is also possible for the holder to be connected to the receptacle means of the computer-controlled positioning unit, for example by being screwed tight or by means of a bayonet lock.

It is now possible to carry out a calibration with the aid of the holder, preferably by aligning the reference element with a zero plane which assumes a predetermined position with respect to the computer-controlled positioning unit. To this end, the holder is positioned by the positioning unit such that the reference element is in contact with the zero plane. It is now possible to align, e.g. set to 0, an appropriate setting of the positioning unit. This value is preferably stored internally by the computer-controlled positioning unit such that it is available for subsequent positioning of an analog or, optionally, for a plurality of positioning actions.

As described in detail below, an intermediate piece is preferably attached to the holder after the calibration has taken place, such that the analog positioner according to the invention is now available attached to the positioning unit and in a calibrated fashion. The dimension and precise arrangement of the intermediate piece on the holder is preferably known and is taken into account during the subsequent positioning by the computer-controlled positioning unit.

For the purposes of the positioning process, the first end of the intermediate piece is first of all attached to the second holder end. The holder receptacle region of the intermediate piece is in the process affixed to the holder with the aid of the attachment unit. The analog is subsequently attached to the second end of the intermediate piece with the aid of the analog receptacle region. In this case, it is important that the intermediate piece and the analog, respectively, cannot move, or can only move minimally, with respect to the holder during the positioning process. Undesirable release of the analog from the intermediate piece or of the latter from the holder is prevented by the interaction between the analog and the analog receptacle region and by the interaction between the holder receptacle region and the attachment unit, respectively. Here, a displacement between the analog and the intermediate piece is preferably prevented by friction coupling and/or positive locking and a displacement between the intermediate piece and holder is preferably prevented by positive locking.

Alternatively, the analog can also be connected directly—without intermediate piece—to the second holder end.

The reference element at the positioning section of the analog positioner according to the invention serves to provide information to the computer-controlled positioning unit in respect of the position and arrangement of the holder, and hence also in respect of the intermediate piece and/or analog. Thus, the reference element can for example impart information in respect of the position in space (particularly in respect of height), in respect of the inclination or in respect of the alignment in the direction of rotation. As a result, the computer-controlled positioning unit can “orient” itself in space, i.e. be calibrated appropriately, such that the analog can be placed at precisely the desired site in the model.

During the positioning process, the analog is now moved through space on the analog positioner by means of the computer-controlled positioning unit and inserted into a drilled hole in a model. After this actual positioning, the analog is secured in the prepared drilled hole of the model, for example by embedding into a polymer or by adhesive bonding. The analog positioner, i.e. the holder together with the intermediate piece, is subsequently released from the analog.

According to the above-described positioning process, the analog is temporarily—i.e. for a restricted period of time—attached to the intermediate piece. The period of time of the temporary attachment is typically of the order of minutes. Since the value of the calibration is preferably stored, it is not mandatory for the positioning process to be completed after a few minutes: it can also be interrupted and, if necessary, be completed on a subsequent day.

The term “releasable connection” contains the interpretation that the holder can be removed from the intermediate piece without the holder, in particular the attachment unit thereof, or the intermediate piece being damaged in the process. Hence both the holder and the intermediate piece can be used a number of times, if desired.

The analog, which usually has a substantially circular cylindrical design, is affixed to the analog receptacle region of the intermediate piece. Here, the analog is preferably attached to the intermediate piece by means of the coronal end of said analog, i.e. by means of the end that corresponds to the coronal end of a dental implant. Hence that end of the analog which corresponds to the anchoring part of the implant and is intended for insertion into a drilled hole in a model faces away from the intermediate piece or from the analog positioner. This enables simple insertion of the analog into the drilled hole of the model.

If need be, a further analog can be placed in a further drilled hole after removing the analog positioner from the analog. To this end, it is possible to reuse the same intermediate piece one more time. The model fully equipped with the analogs can impart on the user a precise visual impression of the subsequent conditions in the mouth of the patient and serves the user, in particular, as a basis for producing custom-fit crowns and abutments.

In the present document, the removal force refers to the force which has to be exerted in the axial direction in order to release the holder and the analog, respectively, from the intermediate piece. In a preferred embodiment of the analog positioner, the connection between the intermediate piece and the holder defines a first removal force which is the minimum amount of force that needs to be exerted in the axial direction in order to release the intermediate piece from the holder.

The intermediate piece and the holder are preferably designed such that the connection between intermediate piece and holder is established by joining these in the axial direction. Here, the axial direction for joining is directed in the opposite direction to the aforementioned axial direction for removing the intermediate piece. As a result, the connection can be established and released in a simple and quick fashion. It enables the intermediate piece to be affixed to the holder without problems and can likewise be released again without effort at the wanted time. Moreover, there is no need for further attachment elements or similar aids, which could have an adverse effect on guiding the analog positioner in a precise manner. Moreover, the connection can also be established and released simply by a computer-controlled positioning unit.

In a preferred embodiment, the intermediate piece can be connected to the holder by means of a snap lock. Here, a snap-on connection is established between the holder receptacle region and the attachment unit of the holder. A snap lock enables simple plugging-on of the intermediate piece and later a just as simple removal, with, at the same time, it being possible to ensure a secure connection to the holder during the actual positioning process.

The snap-on connection is preferably embodied such that the holder receptacle region undergoes elastic deformation when the intermediate piece is attached and subsequently returns to the initial position. The snap-on connection, which is preferably released or established by exerting force along the longitudinal axis of the intermediate piece, is a connection that can be established in a simple and quick fashion which can also be released in a simple fashion. It enables the holder to be affixed to the intermediate piece without problems and can likewise be released without effort at the desired time. Moreover, there is no need for further attachment elements or similar aids, which could have an adverse effect on guiding the analog positioner in a precise manner.

The holder receptacle region can alternatively also be connected to the attachment unit of the holder by means of a screw lock or a bayonet lock. Positive locking connections, such as a dovetail connection in which the holder is attached to the intermediate piece in a radial fashion, are also possible in the axial direction.

The reference element is arranged at the second end of the holder in a preferred embodiment. By arranging the reference element on the frontal side, which lies axially opposite the receptacle section, of the holder, the calibration in space is made simpler and the accuracy is increased: by way of example, the reference element can simply be brought into contact with a desired zero plane, for example by being supported thereon.

The reference element of the holder is preferably part of the attachment unit. The reference element can thus also assume an attachment function in addition to the reference function. Here, the reference element can form the attachment unit on its own or with one, or more, further attachment elements. In this embodiment, the reference element serves for calibrating the computer-controlled positioning unit in respect of a zero plane. To this end, the reference element is brought into contact with a zero plane in space prior to the insertion of an analog into the model, and the system is calibrated thus. As a result of a preceding entry of the dimensions and shape of the model and of the relative position of the drilled holes contained in the model, into which drilled holes the analogs are intended to be inserted, (this data is usually available from the computer-controlled modeling of the model) into the computer-controlled positioning unit, the latter is put into the position where it can correctly place the analogs into the model within the scope of an automatic method.

In a preferred embodiment, the reference element and/or the attachment unit comprises a ball head. It is very easy to bring a spherical reference element into contact with a zero plane in space and this enables a simple calibration of the positioning unit because the height determination in particular can be carried out in a relatively simple manner by means of trigonometry. Moreover, the result of this is a continuous transition from one contact point to the next if the incline of the zero plane, with which the ball head is brought into contact, is changed.

However, as an alternative the reference element could, for example, also have a shape like a circular cone, a needle or a pin. In particular, a reference element with a tip that is as fine but as stable as possible would be advantageous because in this the contact point remains unchanged in the case of a relatively large number of zero planes with different inclines.

In a particularly preferred embodiment, the reference element is part of the attachment unit and comprises the ball head, with the latter preferably serving both as reference element and as at least a part of the attachment unit. In a corresponding preferred embodiment of the intermediate piece, the holder receptacle region comprises a cap and a hollow cylindrical receptacle region with a substantially circular cylindrical cross section. Here, the internal diameter of the receptacle regions corresponds to the maximum external diameter of the ball head. The cap and the hollow cylindrical receptacle region are preferably arranged along the longitudinal axis of the intermediate piece. In this embodiment the intermediate piece can very easily be connected to the ball head, for example by a means of a snap lock or by means of resilient fingers, and can also be released therefrom in a very simple fashion. Here, the force required for releasing the connection between ball head and intermediate piece should be selected such that the intermediate piece, and hence the analog as well, cannot inadvertently release itself from the holder, but that the user can exert this force without problems, preferably without further aids.

A snap lock is preferred, in particular, when the attachment means has a ball head. Thus, it is particularly preferable for the hollow cylindrical receptacle region of the intermediate piece to have two or more resilient fingers and/or a snap-on lug at the frontal end thereof. The ball head of the holder is held by these resilient fingers in the connected state and/or it establishes a snap-on connection with the intermediate piece.

In a particularly preferred embodiment, the holder receptacle region has at least two, preferably four resilient fingers. A number of slots, cutouts or openings, corresponding to the number of resilient fingers, are arranged between the resilient fingers. The resilient fingers consist of an elastic material.

The hollow cylindrical receptacle region preferably has a snap-on lug at a frontal end, i.e. at the end directed toward the cap. This snap-on lug is preferably formed in the form of an inwardly directed projection which runs in the circumferential direction, and is placed over the ball head in order to establish a connection with the holder.

However, alternatively the intermediate piece can, for example, also be connected to the attachment unit of the holder by means of a screw lock or a bayonet lock.

The attachment unit of the holder preferably comprises an abutment surface for the intermediate piece. This abutment surface serves to prevent the intermediate piece from, in the axial direction, moving too far in the direction of the receptacle section of the holder. Moreover, the abutment surface can also serve to affix the intermediate piece in the radial direction.

In a particularly preferred embodiment, the abutment surface is at least approximately annular or circular. The intermediate piece accordingly has a cap with a frontal end having a shape that complements the abutment surface. The external radius of the abutment surface is matched to the external radius of the frontal end of the intermediate piece. The abutment surface is thus in contact with the frontal end in the connected state.

The frontal end of the cap is preferably likewise approximately annular. This embodiment lends additional stability to the connection. In particular, it is possible to prevent the intermediate piece from being displaced in a radial direction relative to the holder. Moreover, a parallel alignment of the longitudinal axis of the intermediate piece with the longitudinal axis of the holder is ensured and bending of the holder with respect to the intermediate piece is prevented.

The described embodiment renders it possible simply to plug the holder onto the intermediate piece and subsequently likewise renders it possible just as easily to remove the holder from the intermediate piece with, at the same time, it being possible to ensure a secure connection to the holder while the analog is being fitted into place. This embodiment is advantageous in that the snap-on connection is self-centering.

In an alternative embodiment of the holder—without the use of the intermediate piece—the external radius of the abutment surface is matched to the external radius of the analog.

In both cases, it is particularly advantageous for the abutment surface not to protrude significantly over the intermediate piece or the analog in the radial direction so that the holder can also be used for positioning an analog in the case of restricted spatial conditions, for example if the planned implantation site is situated between two existing teeth. However, on the other hand, the holder must have a certain minimum diameter in order to guarantee a sufficiently high stability and simple handling of the holder. Therefore the external diameter of the abutment surface is preferably the same as, or of the order of, the external diameter of the intermediate piece or analog, for example slightly larger or slightly smaller.

Alternatively, it is also feasible for the abutment surface to have a different shape, for example the shape of a polygon.

According to a further embodiment, the analog positioner additionally comprises a computer-controlled positioning unit.

In a further aspect, the present invention relates to a set comprising at least one analog positioner according to the invention and, additionally, at least one analog.

The external diameters of utilized standard analogs usually correspond to the external diameters of the utilized standard dental implants. Typical external diameters of dental implants are e.g. 5.0 mm and 2.8 mm.

In principle, a set with only one holder can be used to position an analog with any external diameter: it is only the intermediate piece that is matched to the dimensions and shape of the analog. In a preferred embodiment, the set therefore comprises at least two intermediate pieces, with the intermediate pieces respectively being matched to various analogs which, for example, have different external radii. However, it may by all means be advantageous for the set to have two or more holders, with, for example, one of said holders being a particularly narrow holder which is suitable, in particular, for sites that are difficult to access, for example between two existing teeth.

The connection between the intermediate piece and the analog defines a second removal force which is the minimum amount of force that needs to be exerted in the axial direction for removing the intermediate piece from the analog. The connection is preferably established by joining the intermediate piece and the analog in the opposite axial direction. As a result of this, the connection can be established and released in a simple and quick fashion. It allows the analog to be affixed to the intermediate piece without problems and can likewise be easily released again at a desired time. Moreover, there is no need for further attachment elements or similar aids, which could have an adverse effect on the precise guidance of the analog positioner. Moreover, the connection can also easily be established and released by a computer-controlled positioning unit.

In order to position the analog in the model, holder, intermediate piece and analog are interconnected. After the analog has been inserted into the model, the analog positioner is once again released from the analog. Here, the force that needs to be exerted for releasing the connection between analog and intermediate piece is preferably smaller than the one that is required for releasing the connection between holder and intermediate piece such that the whole analog positioner can be separated from the analog in a simple fashion.

In respect of the above-defined removal forces, this means that the first removal force for releasing the connection between the intermediate piece and the holder is greater than the second removal force for releasing the connection between the intermediate piece and the analog. Hence, after the analog has been inserted into the drilled hole in the model, the connection between the intermediate piece and the analog is released when the holder is withdrawn, while the connection between the intermediate piece and the holder remains.

The removal force for releasing the connection between holder receptacle region and holder preferably is approximately 5 to 8 N, for example 6 N, and the force for releasing the connection between analog receptacle region and analog is approximately 2 to 5 N, for example 3 N. In particular, it is preferable for the removal force for releasing the connection between holder receptacle region and holder to be greater than the force for releasing the connection between analog receptacle region and analog such that the intermediate piece can initially be separated from the analog and subsequently from the holder, should this be desired.

The analog receptacle region of the intermediate piece is intended to be affixed to an analog, wherein the coronal end of the analog, i.e. the end with receptacle means for a superstructure, a prosthetic element, a bridge, a crown or else—in the case of a two-piece implant—a tertiary part, is preferably connected to the analog receptacle region of the intermediate piece. Different embodiments can be preferable for the analog receptacle region of the intermediate piece depending on the embodiment of the analog, in particular on the diameter and geometry of the coronal end of the analog, i.e. of the “abutment” of the analog.

In a first preferred embodiment of the analog receptacle region of the intermediate piece, the analog receptacle region is substantially circularly cylindrical and inserted into receptacle means of the analog for establishing the connection with the analog. By way of example, such receptacle means can have the form of a blind hole-type cutout with a substantially circularly cylindrical cross section at the coronal end of the analog. In this case, the external diameter of the analog receptacle region corresponds to that of the receptacle means of the analog such that a releasable connection, e.g. by means of a snap or frictional lock, can be established between intermediate piece and analog. However, alternatively, it would also be possible for the receptacle means of the analog to have an internal thread and for the intermediate piece to be screwed in.

This first embodiment is particularly preferred for holding an analog which is substantially completely embedded in the model (just like the so-called level implants in the bone): thanks to the internal connection between intermediate piece and analog, for example by means of “cross fit”, the intermediate piece, in the region which adjoins the coronal end of the analog in the connected state, has a smaller external diameter than the analog, and so it does not adversely affect the complete insertion of the analog into the model. After fitting the analog into place, this embodiment moreover renders it possible to release the connection between the intermediate piece and the analog by simple, linear withdrawal of the analog positioner.

The analog receptacle region of the intermediate piece preferably has at least two, preferably four, slots that run in the axial direction such that resilient fingers are formed on the analog receptacle region. It is possible to influence the removal force required to release the connection between analog and intermediate piece by means of the length of these slots, the selection of the material of the intermediate piece and of the analog receptacle region and by the size of the area which is in contact with the analog in the connected state.

In a second preferred embodiment of the analog receptacle region of the intermediate piece, the analog receptacle region is substantially hollow circularly cylindrical and holds an insertion region of the analog for establishing a connection with the analog. Here, a snap-on connection is preferably established between the intermediate piece and the analog. According to this embodiment, the intermediate piece preferably comprises a projection, which is based on the implant shoulder and protrudes annularly toward the outside, in the region of the coronal end of the analog. The insertion region of the analog is therefore preferably substantially cylindrical. The analog receptacle region, preferably at the frontal end thereof facing the analog, preferably has an annular snap-on lip. The latter allows the establishment of a snap-on connection between intermediate piece and analog, enabling simple attachment and release. As a result of the selection of the material of the intermediate piece and/or of the analog receptacle region, and, if need be, as a result of the presence of slots, running in the axial direction, in the analog receptacle region, it is possible to influence the removal force for releasing the connection between analog and intermediate piece.

A set preferably contains e.g. at least one intermediate piece according to the first preferred embodiment of the analog receptacle region (for insertion into receptacle means of an analog, i.e. for an internal connection) and at least one intermediate piece according to the second preferred embodiment of the analog receptacle region (for holding an insertion region of an analog, i.e. for an external connection). However, alternatively, it is also possible, for example, that the at least two intermediate pieces are intended for the connection with analogs, the receptacle means or the insertion region of which has a different internal and external diameter; in this case, the analog receptacle regions of the at least two intermediate pieces also have a different diameter. However, it goes without saying that any further combinations of intermediate pieces according to the invention—of the first or second preferred embodiment and with different diameters of the analog receptacle region—can also be used to form a set.

The analogs or types of analog are selected on the basis of the implant types provided for use in a single patient. The selected analogs or types of analog influence the selection of the intermediate pieces and holders to be used. The analogs, intermediate pieces and holders selected thus are unified in a set according to the present invention such that an individually adapted set is provided for the production of a model for a specific patient.

In a further aspect, the present invention relates to a holder for an analog positioner.

In a preferred embodiment, the holder consists of stainless steel. Stainless steel can easily be brought into the desired form and guarantees sufficient stability of the holder. Moreover, a holder of stainless steel can be cleaned without problems and can be used a number of times. However, the holder can alternatively also consist of any other material which has a sufficiently high stability and thus cannot be bent during the positioning process, with, at the same time, it being necessary to guarantee a simple production of the holder. Thus, the holder can, for example, also be made of a metal or a metal alloy, of a ceramic or of a sufficiently hard polymer.

The present invention furthermore relates to a holder according to the alternative embodiment, according to which the holder is suitable for being connected directly to the coronal end of the analog. In this case, the analog preferably has a calibration element for determining the height, and the reference element on the holder serves to determine the alignment of the analog in the rotational direction. Such a reference element for transmitting the information in respect of the alignment of the analog in the rotational direction can for example be embodied as a notch or projection in the holder.

Like the dental implant itself, an analog of a dental implant is also usually not completely rotationally symmetric with respect to the longitudinal axis thereof. Thus, a dental implant with a screw-shaped anchoring part has a male thread, which naturally runs about the implant like a spiral and has a start and an end. Moreover, the coronal end region of the implant or analog often does not have a rotationally symmetrical design either such that an element to be attached thereto (a superstructure, a prosthetic element, a bridge, crown or else—in the case of a two-piece implant—a tertiary part) can only be attached thereto with a specific orientation. In addition to the position and inclination in space, the alignment of the analog in the rotational direction is therefore also indispensable information for the correct positioning, which information can be transmitted to the computer-controlled positioning unit with the aid of the aforementioned reference element.

In order to calibrate the position, in particular the height, and the inclination, the analog is connected in advance to the holder according to the invention as per the alternative embodiment such that the corresponding information can be established with the aid of the calibration element on the analog which, incidentally, is preferably arranged at the apical end thereof and particularly preferably has the shape of a ball head. Following the calibration, the analog can, with the aid of the computer-controlled positioning unit, be placed correctly in the model during an automatic process.

The analog is preferably attached to the holder by means of a snap lock or by means of resilient fingers. As a result, the analog can easily be plugged on the holder and can just as easily be again released therefrom. Here, the force required for releasing the connection between holder and analog should be selected such that the analog cannot inadvertently release itself from the holder, but that the user can exert this force without problems, preferably without further aids.

However, alternatively, the analog can for example be connected to the attachment unit of the holder by means of a screw lock or a bayonet lock.

In a preferred alternative embodiment, the attachment unit of the holder comprises an abutment surface for the analog. This abutment surface serves to prevent the analog from, in the axial direction, moving too far in the direction of the receptacle section of the holder. Moreover, the abutment surface can also serve to affix the analog in the radial direction.

In a particularly preferred alternative embodiment, the abutment surface is at least approximately annular or circular and the external radius of the abutment surface is matched to the external radius of the analog. Here, it is particularly advantageous for the abutment surface not to protrude significantly over the analog in the radial direction so that the holder can also be used for positioning an analog in the case of restricted spatial conditions, for example if the planned implantation site is situated between two existing teeth. However, on the other hand, the abutment surface on the holder also serves to protect the coronal end region of the analog from the material used for anchoring, e.g. from an adhesive, while the analog is being anchored in the model. Therefore the external diameter of the abutment surface is preferably the same size as, or slightly larger than, the external diameter of the analog.

Alternatively, it is also feasible for the abutment surface to have a different shape, for example the shape of a polygon.

In a preferred embodiment, the holder according to the alternative embodiment also consists of stainless steel. Stainless steel can easily be brought into the desired form and guarantees sufficient stability of the holder. Moreover, a holder of stainless steel can be cleaned without problems and can be used a number of times. However, the holder can alternatively also consist of any other material which has a sufficiently high stability and thus cannot be bent during the positioning process, with, at the same time, it being necessary to guarantee a simple production of the holder. Thus, the holder can, for example, also be made of a metal or a metal alloy, of a ceramic or of a sufficiently hard polymer.

The present invention also relates to a set comprising at least one holder according to the alternative embodiment and at least one analog which can be connected to the holder in a releasable manner.

In the alternative embodiment of the holder according to the invention, it is particularly advantageous for the external radius of the attachment unit to be matched to the external radius of the analog to be positioned. As a result, connecting the holder to the analog is simplified, and moreover a material (adhesive) used to attach the analog in the model is reliably prevented from reaching the interior of the analog. Therefore the set in a further embodiment comprises at least two holders according to the alternative embodiment, with the attachment units thereof having a different external radius. This set preferably also comprises at least two analogs, the external radii of which are matched to the external radii of the attachment units. In a preferred embodiment, these sets according to the invention additionally comprise a computer-controlled positioning unit.

In a further aspect, the present invention relates to an intermediate piece for an analog positioner.

An intermediate region is preferably formed between the holder receptacle region and the analog receptacle region of the intermediate piece, which intermediate region can simplify the handling and, in particular, gripping of the intermediate piece. Such an intermediate region is preferably likewise arranged along the longitudinal axis and substantially has a circularly cylindrical design. The maximum diameter of the intermediate region should be smaller than the maximum diameter of the holder and/or of the analog, to which the intermediate piece should be connected. As a result, the intermediate piece is prevented from wedging when being inserted into the drilled hole in the model. On the other hand, a too small diameter of the intermediate region is not desired either for practical reasons because a too narrow intermediate region could make it more difficult to grip and place the intermediate piece easily using just the fingers. Moreover, the external diameter of the intermediate region need not stay the same size over the whole length thereof (parallel to the longitudinal axis). The external diameter of the intermediate region preferably tapers toward the holder receptacle region and toward the analog receptacle region.

In a preferred embodiment, the intermediate piece according to the invention consists of plastic, in particular of polyether ether ketone (PEEK). Suitable polymers can be brought into the desired form in a particularly simple manner and are moreover sufficiently elastic to enable the function of the resilient fingers.

In a preferred embodiment, the intermediate piece according to the invention moreover comprises a reference element, which serves to transmit information to the computer-controlled positioning unit in respect of the alignment of the analog in the rotational direction. A dental implant, and hence also a corresponding analog, is usually not completely rotationally symmetric with respect to the longitudinal axis thereof. It may therefore be important that the implant or analog is placed in the bone or model with a specific rotational alignment. So that the computer-controlled positioning unit can monitor this alignment in accordance with the preceding planning, it must first of all “know” in which position the analog is with respect to the rotation. A corresponding reference element on the intermediate piece can for example be embodied as groove, slot or projection. In order to transmit the information in respect of the alignment of the analog, the reference element interacts with corresponding counter elements on the analog or on the holder.

Finally, the present invention also relates to the use of the analog positioner for positioning an analog in a drilled hole in a model and to the use of the holder according to the alternative embodiment for temporarily holding an analog and for positioning the analog in a drilled hole in a model.

### BRIEF DESCRIPTION OF THE DRAWINGS

The invention will be explained in more detail on the basis of exemplary embodiments illustrated in the drawing. In purely schematic form:

FIG. 1 shows a perspective illustration of a holder together with an intermediate piece and an analog, with holder, intermediate piece and analog not being connected;

FIG. 2 shows a longitudinal section through the holder, the intermediate piece and the analog from FIG. 1;

FIG. 3 shows a side view of a first embodiment of an intermediate piece according to the invention;

FIG. 4 shows a longitudinal section through the intermediate piece from FIG. 3;

FIG. 5 shows a perspective illustration of the holder, the intermediate piece and the analog from FIG. 1, with holder, intermediate piece and analog being interconnected;

FIG. 6 shows a longitudinal section through the holder, the intermediate piece and the analog from FIG. 5; and

FIG. 7 shows a longitudinal section through a second embodiment of an intermediate piece according to the invention.

### DETAILED DESCRIPTION

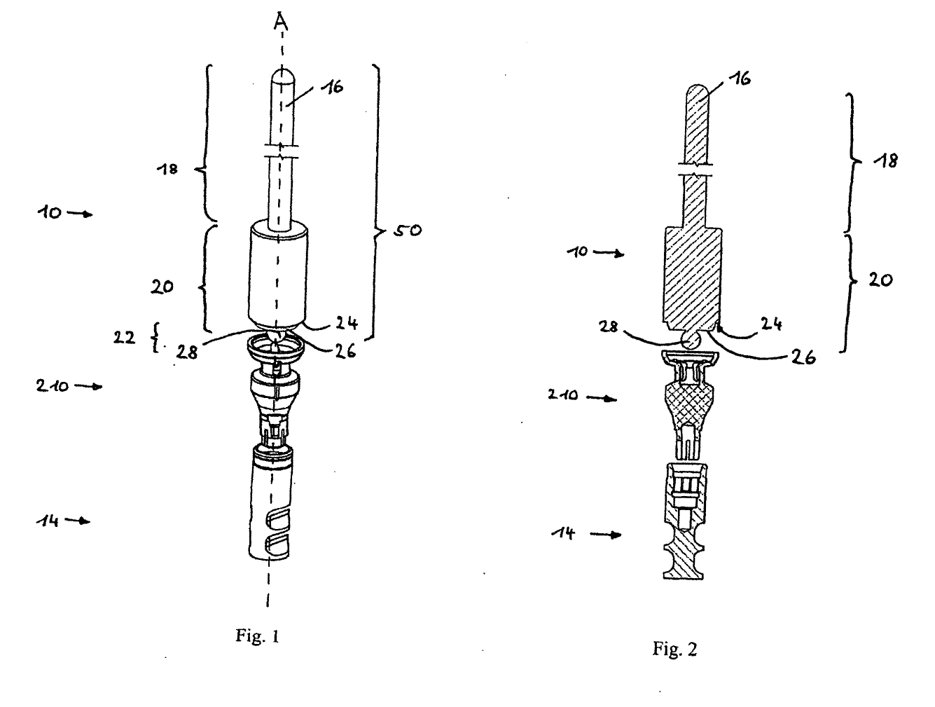

FIG. 1 shows a perspective illustration of an analog positioner according to the invention, comprising a holder 10 and an intermediate piece 210 as well as an analog 14 of a dental implant. The holder 10 shown, the intermediate piece 210 and the analog 14 are not interconnected. Therefore FIG. 1 shows the individual parts prior to assembly and prior to the positioning of the analog 14 in a model.

FIG. 2 shows a longitudinal section through the holder 10, the intermediate piece 210 and the analog 14 from FIG. 1, with these also being illustrated in a separated state in this case. The features of the parts shown in FIGS. 1 and 2 (holder 10, intermediate piece 210 and analog 14) are therefore described together in the following text:

The shown holder 10 consists of stainless steel. However, the holder 10 could alternatively also consist of a different suitable material, such as e.g. a metal, an alloy, a ceramic or a suitable polymer.

The holder 10 comprises a shaft 16 with a receptacle section 18 and, adjoining it in an axial direction (relative to the longitudinal axis A), a positioning section 20. The receptacle section 18 is intended to be inserted into receptacle means of a computer-controlled positioning unit (not shown) and is substantially circularly cylindrical. Here, the receptacle section 18 is anchored in the receptacle means of the computer-controlled positioning unit by means of a snap lock.

The positioning section 20 of the holder 10 comprises an attachment unit 22 with an annular abutment surface 24, a cylinder section 26 and a ball head 28. The attachment unit 22 serves to connect the intermediate piece 210 to the holder 10 in a releasable fashion. Alternatively, it would also be possible that the attachment unit 22 has a female or male thread or a bayonet lock (not shown).

Together with the intermediate piece 210, which can be attached to the attachment unit 22 in a releasable fashion, the holder 10 shown in FIGS. 1 and 2 forms an analog positioner 50 which renders it possible to position the analog 14 in a model.

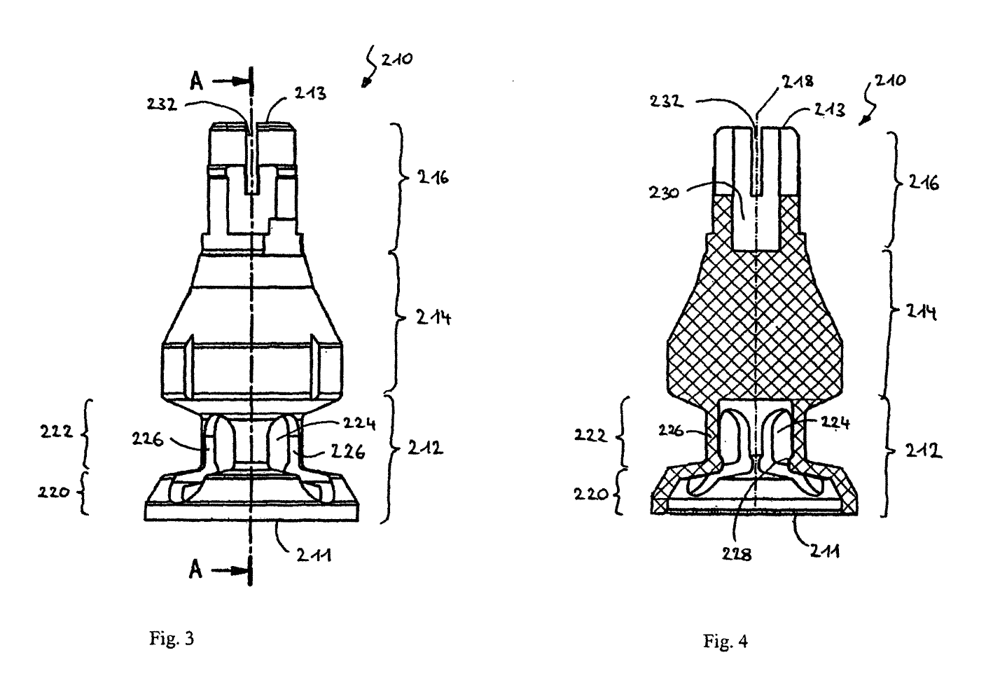

FIG. 3 shows a side view of a first embodiment of an intermediate piece 210 according to the invention as per the first preferred embodiment. FIG. 4 shows a longitudinal section of the same intermediate piece 210 along the axis A-A. For reasons of simplicity, these two figures will therefore be discussed together.

The shown intermediate piece 210, which for example consists of PEEK, has a longitudinal axis 218, a first end 211 and a second end 213, which lies axially opposite the first end 211. Arranged on the first end 211 there is a holder receptacle region 212 for being connected in a releasable fashion to a holder and arranged on the second end 213 there is an analog receptacle region 216 for temporarily holding an analog. The holder receptacle region 212 comprises a cap 220 and a hollow cylindrical receptacle region 222.

The intermediate piece 210 has an intermediate region 214 between holder receptacle region 212 and analog receptacle region 216. In the illustrated embodiment, the holder receptacle region 212, the intermediate region 214 and the analog receptacle region 216 are substantially circularly cylindrical. The holder receptacle region 212, the intermediate region 214 and the analog receptacle region 216 are arranged along the longitudinal axis 218, with the intermediate region 214 lying between the holder receptacle region 212 and the analog receptacle region 216 in the longitudinal direction.

The holder receptacle region 212 furthermore has four openings 224, which partly extend over the cap 220 and the cylindrical receptacle region 222 and are evenly distributed in the circumferential direction. In the region of the hollow cylindrical receptacle region 222, the openings 224 run substantially parallel to the longitudinal axis A and extend over practically the whole length of the receptacle region 222. In the hollow cylindrical receptacle region 222, four resilient fingers 226, which partly also extend over the cap 220, are formed in the circumferential direction between the openings 224. Alternatively, resilient fingers 226 and the openings 224 can also extend completely over the hollow cylindrical receptacle region 222 and the cap 220. The intermediate piece 210 shown in FIGS. 3 and 4 has a closed ring at the outer end of the holder receptacle region 212.

The intermediate region 214 of the intermediate piece 210 shown in FIGS. 3 and 4 has a substantially circularly cylindrical design, with the external diameter thereof tapering toward the holder receptacle region 212 and toward the analog receptacle region 216. The maximum diameter of the intermediate region 214 is smaller than the maximum diameter of the holder 10 and/or of the analog 14 to which the intermediate piece 210 should be connected. This prevents the intermediate piece 210 from wedging during the insertion into the drilled hole in the model. On the other hand, a too small diameter of the intermediate region 214 is unwanted for practical reasons. Thus, the diameter of the intermediate region 214 enables simple handling, in particular simple gripping and placing of the intermediate piece 210 using just the fingers.

The analog receptacle region 216 of the intermediate piece 210 as per FIGS. 3 and 4 is substantially circularly cylindrical and has a concentric blind hole 230 along the longitudinal axis 218. Moreover, four slots 232 are formed in the axial direction in the hollow cylindrical analog receptacle region 216.

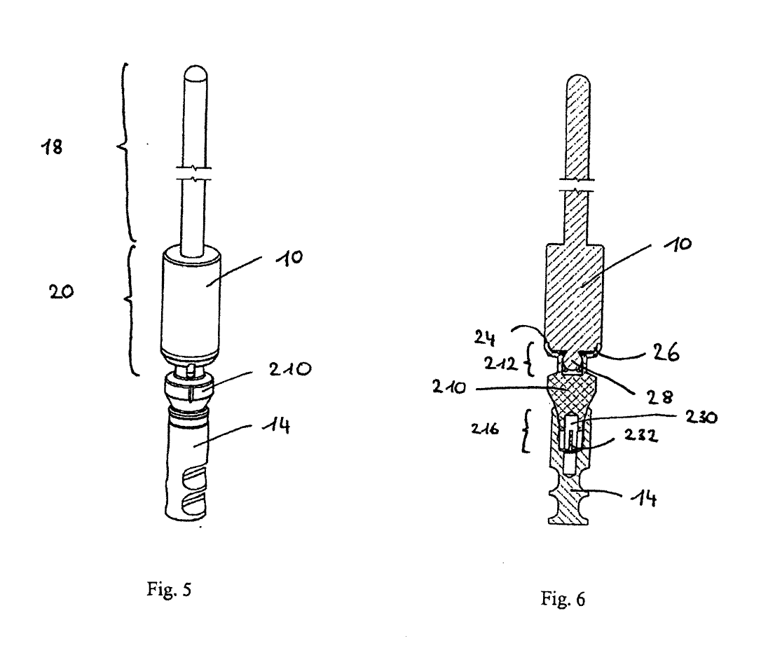

FIG. 5 shows a perspective illustration of the holder 10 according to the invention, with said holder being connected to the analog 14 from FIG. 1 via the intermediate piece 210. FIG. 6 shows a longitudinal section through the same arrangement.

The cylinder section 26 of the holder 10 is, when the intermediate piece 210 is put on, inserted into the holder receptacle region 212 of the intermediate piece 210 and, in the assembled state, prevents the intermediate piece 210 from moving in the radial direction (i.e. perpendicular to the longitudinal axis A) relative to the holder 10. The annular abutment surface 24 prevents the intermediate piece 210, in the assembled state, from being able to be displaced toward the receptacle section 18 in the axial direction.

The holder receptacle region 212 can be connected to the holder 10 by means of a snap-on connection. To this end, the ball head 28 of the holder 10 is inserted through the cap 220 into the hollow cylindrical receptacle region 222 between the resilient fingers 226. Each of the four resilient fingers 226 has a snap-on lug 228. When the holder is connected to the intermediate piece 210, the ball head 28 of the holder 10 comes into contact with the snap-on lugs 228. As a result of the elasticity of the resilient fingers 226, the snap-on lugs 228 can be pressed radially outward by the ball head 28 during the connection and the release, and thus experience a deflection. Finally, the ball head 28 comes to rest entirely in the hollow cylindrical receptacle region 222. The embodiment of the analog positioner 50 as per FIGS. 1, 2, 5 and 6 allows simple and quick fixing of the holder 10 on the intermediate piece 210 and is particularly well suited to a machine-controlled or computer-controlled use because the connection is established by only a single, linear movement.

In the connected state, a first end of the cap 220 is in contact with the abutment surface 24 of the attachment unit 22 of the holder 10. The internal diameter of the frontal end of the cap 220 corresponds to the internal diameter of the abutment surface 24, and the external diameter of the frontal end of the cap 220 corresponds to the external diameter of the abutment surface 24. Moreover, the cylinder section 26 of the attachment unit 22 of the holder 10 is inserted into the cap 220. As a result, additional stability is lent to the connection between the holder 10 and the intermediate piece 210. The abutment surface 24 prevents the intermediate piece 210 from slipping along the longitudinal axis 218 in the direction of the receptacle section 18. Moreover, a displacement of the intermediate piece 210 in the radial direction relative to the holder 10 is prevented.

In the connected state, the ball head 28 is situated in the hollow cylindrical receptacle region 222 of the intermediate piece 210. The holder 10 is prevented from slipping along the longitudinal axis 218 by the snap-on connection between the resilient fingers 226 and the ball head 28.

The ball head 28 assumes a dual function: it firstly serves as a reference element for calibrating the computer-controlled positioning unit in respect of a zero plane, i.e. for determining the position of the holder 10, particularly the height thereof. However, the ball head 28 secondly also serves as attachment unit 22.

The removal force for releasing the connection between the holder receptacle region 212 and the holder 10 can, for example, be determined by the geometry of the openings 224 and/or the geometry of the resilient fingers 226, in particular by the shape, thickness and width of the resilient fingers 226, and by the properties, such as elasticity, of the material of the holder receptacle region 212. The removal force can additionally also be influenced by the size and the shape of the snap-on lugs 228. The removal force for releasing the connection between the holder receptacle region 212 and holder 10 preferably is between 5 and 8 N.

When the analog 14 is connected to the intermediate piece 210 as per the first preferred embodiment, shown in FIGS. 3 and 4, the analog receptacle region 216 of the intermediate piece 210 is inserted into receptacle means of the analog 14. An internal connection is established in the process. The receptacle means of the analog 14 preferably comprises a blind hole-type cutout with a substantially circular cylindrical cross section at the coronal end of the analog 14. In order to connect intermediate piece 210 and analog 14, the analog receptacle region 216 is inserted into this receptacle means. In doing so, the outer ends of the analog receptacle region 216 are pressed together, i.e. deflected toward the longitudinal axis 218 of the intermediate piece 210. In this embodiment, the releasable connection between intermediate piece 210 and analog 14 is based on a frictional lock between the analog receptacle region 216 and the receptacle means of the analog 14. It allows simple and quick fixing of the analog 14 on the intermediate piece 210, or on the analog positioner 50, and is particularly well suited to a machine-controlled or computer-controlled use because the connection is both established and released by only a single, linear movement. However, alternatively it would also be possible for the receptacle means of the analog 14 to have a female thread and for the intermediate piece 210 to be screwed in.

The removal force in respect of the connection between the analog 14 and the analog receptacle region 216 of the intermediate piece 210 can be influenced by the geometry of the slots 232 and by the material of the analog receptacle region 216. The removal force can therefore be set by e.g. the length of the slots 232. The removal force for releasing the connection between analog receptacle region 216 and analog 14 is preferably between 3 and 5 N.

In order to position the analog 14, the holder 10 is first of all connected to the computer-controlled positioning unit (not shown), The computer-controlled positioning unit is subsequently calibrated by placing the ball head 28 onto a zero plane such that said positioning unit is able to “orient” itself in space. The holder 10 is then connected in a releasable fashion to the intermediate piece 210 and the analog 14, and the latter is, at the planned site, inserted into a drilled hole already present in the model. After the analog 14 has been securely anchored in the model, for example by adhesive bonding, it firstly is the connection between analog 14 and intermediate piece 210 that is released such that the whole analog positioner 50 can be removed from the analog 14.

The holder 10 and the intermediate piece 210 can be separated from one another and cleaned such that they can at a later stage be used for a further positioning process. However, alternatively, it is of course also possible to dispose of the holder 10 and/or the intermediate piece 210 after a single use.

The removal force for releasing the connection between the holder receptacle region 212 and the holder 10 and the removal force for releasing the connection between the analog receptacle region 216 and the analog 14 are independent of one another in the shown embodiment.

The holder receptacle region 212 of the intermediate piece 210 is typically connected to the holder 10 before the time at which the analog receptacle region 216 of the intermediate piece 210 is connected to the analog 14. However, the connections can also be established in the reverse sequence.

The removal force for releasing the connection between the analog 14 and the analog receptacle region 216 of the intermediate piece 210 is preferably selected such that it is smaller than the removal force in respect of the connection between the holder 10 and the holder receptacle region 212. What this ensures is that, after inserting the analog 14 into the drilled hole in the model and when the analog positioner 50 is withdrawn, the connection between the analog 14 and the analog receptacle region 216 of the intermediate piece 210 is released while the connection between the holder receptacle region 212 and the holder 10 is maintained. The advantage of this is that the analog positioner 50 remains intact and therefore is ready for holding a further analog.

The analog positioner 50 together with the analog 14 forms a set according to the invention.

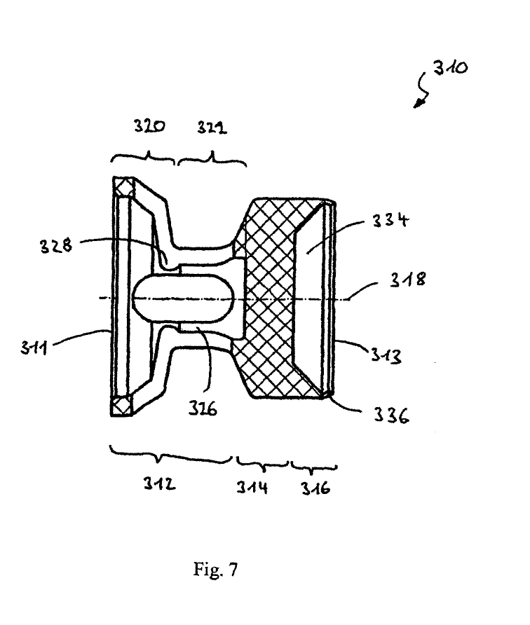

FIG. 7 shows a longitudinal section through a second embodiment of an intermediate piece 310 according to the invention as per the second preferred embodiment. The holder receptacle region 312 in this intermediate piece 310 has substantially the same design as in the first embodiment shown in FIGS. 3 and 4. By contrast, the analog receptacle region 316 has a snap-on connection and is intended for holding an insertion region of an analog. The analog receptacle region 316 is substantially hollow circular cylindrical and has a conical frustum-shaped recess 334 at one frontal end 313. Moreover, a snap-on lip 336 in the form of an inwardly protruding, annular projection is formed in the circumferential direction on the frontal end 313.

The intermediate piece 310 shown in FIG. 7 is used to establish an external connection to an analog. In the connected state, the snap-on lip 336 comprises a coronal end region of the abutment of the analog, which corresponds to the implant shoulder.

The removal force for releasing the connection between the analog and the analog receptacle region 316 is preferably smaller than the removal force for releasing the connection between the holder 10 and the holder receptacle region 312.

1. An analog positioner for fitting an analog into place during preoperative planning, said analog positioner comprising a holder and at least one intermediate piece for temporarily fixing the analog to the holder, wherein
the holder comprises a shaft having a receptacle section, to be held in receptacle means of a computer-controlled positioning unit, and, adjoining axially thereto, a positioning section having an attachment unit, the receptacle section being arranged at a first holder end and the attachment unit being arranged at a second holder end lying axially opposite the receptacle section, the positioning section having a reference element, and wherein
the intermediate piece has a longitudinal axis, a first end having a holder receptacle region for connecting in a releasable fashion the intermediate piece to the attachment unit of the holder and a second end lying axially opposite the first end having an analog receptacle region for temporarily holding the analog,
wherein the intermediate piece can be connected to the holder by means of a snap-on connection between the holder receptacle region and the attachment unit, and
wherein the reference element of the holder is part of the attachment unit and comprises a ball head, and wherein the holder receptacle region of the intermediate piece comprises a cap and a hollow cylindrical receptacle region with a substantially circular cylindrical cross section, with the internal diameter of the receptacle region corresponding to the maximum external diameter of the ball head.

2. The analog positioner as claimed in claim 1, wherein the connection between the intermediate piece and the holder defines a first removal force which is the minimum amount of force that needs to be exerted in the axial direction for removing the intermediate piece from the holder, and wherein the connection is established by joining the intermediate piece and the holder in the opposite axial direction.

3. (canceled)

4. (canceled)

5. The analog positioner as claimed in claim 1, wherein the hollow cylindrical receptacle region of the intermediate piece has two or more resilient fingers and/or a snap-on lug at the frontal end thereof, with, in the connected state, the ball head of the holder being held by the resilient fingers and/or establishing a snap-on connection with the intermediate piece.

6. The analog positioner as claimed in claim 1, wherein the attachment unit of the holder comprises an abutment surface for the intermediate piece, the abutment surface being at least approximately annular or circular and the intermediate piece having a cap with a frontal end having a shape that complements the abutment surface, with the external radius of the abutment surface being matched to the external radius of the frontal end of the intermediate piece and the abutment surface being in contact with the frontal end in the connected state.

7. The analog positioner as claimed in claim 1, additionally comprising a computer-controlled positioning unit.

8. A set comprising the analog positioner as claimed in claim 1 and additionally at least one analog,
wherein the connection between the intermediate piece and the analog defines a second removal force which is the minimum amount of force that needs to be exerted in the axial direction for removing the intermediate piece from the analog, and wherein the connection is established by joining the intermediate piece and the holder in the opposite axial direction,
wherein the first removal force for releasing the connection between the intermediate piece and the holder is greater than the second removal force for releasing the connection between the intermediate piece and the analog.

9. (canceled)

10. (canceled)

11. The set as claimed in claim 8, wherein the analog receptacle region of the intermediate piece is substantially circularly cylindrical and inserted into receptacle means of the analog for establishing the connection with the analog.

12. The set as claimed in claim 11, wherein the analog receptacle region of the intermediate piece has at least two slots running in the axial direction such that resilient fingers are formed at the analog receptacle region.

13. The set as claimed in claim 8, wherein the analog receptacle region of the intermediate piece is substantially hollow circularly cylindrical and holds an insertion region of the analog for establishing a connection with the analog, with a snap-on connection preferably being established between the intermediate piece and the analog.

14. (canceled)

15. (canceled)

16. (canceled)

17. The use of the analog positioner as claimed in claim 1 for positioning an analog in a drilled hole in a model.

18. (canceled)
